(19) United States
(12) Patent Application Publication
(10) Pub. No.: US 2010/0150655 A1
(43) Pub. Date: Jun. 17, 2010

(54) INFLATABLE BOOM

(75) Inventor: Anthony David Kilvert, Dorset (GB)

Correspondence Address: SNELL & WILMER L.L.P. (Main), 400 EAST VAN BUREN, ONE ARIZONA CENTER, PHOENIX, AZ, 85004-2202, US

(73) Assignee: PLANNING SOLUTIONS LIMITED, Hampshire (GB)

(21) Appl. No.: 12/598,066

(22) PCT Filed: Apr. 29, 2008
(86) PCT No.: PCT/GB08/01465

§ 371 Date: Oct. 29, 2009

(30) Foreign Application Priority Data
Apr. 30, 2007 (GB) 0708332.2
Jul. 20, 2007 (GB) 0714227.6
Apr. 21, 2008 (GB) 0807240.7

(51) Int. Cl. B63C 9/00; E02B 15/06; B63C 9/08; B63C 9/20; B63C 9/22; F21S 4/00; F21V 1/00; H05B 39/00

(52) U.S. Cl. 405/68; 441/80; 362/249.01; 362/235; 315/313

(57) ABSTRACT

An inflatable boom (1), the boom being elongate and being provided with at least one line (4) by means of which the boom can be launched from a watercraft into surrounding water. Typically, the boom would be launched into the water by means of a compressed gas launcher (6) launching a projectile (5) on the end of the line. The inflated boom (1) can be used for lifesaving operations to rescue a man overboard (10), or for the recovery of oil spills on water. Also, the boom may be provided with a light source (15), typically internal to the boom (1), with windows (19) along the length of the boom (1) allowing light transmission from the internal light source (15). To this end, the internal wall (20) of the boom may be reflective.

This invention relates to an inflatable boom.

So-called “man-overboard” situations are a well known peril of marine navigation. If a member of the crew or a passenger of a ship or boat fall or jump overboard it is generally imperative to retrieve them from the water as quickly as possible; this is particularly important where the water is sufficiently cold to cause hypothermia, such as is likely in the North Sea off the United Kingdom.

Traditional life buoys, of the form of an inflatable ring, will be familiar to anyone who has traveled by sea. However, these have to be aimed very accurately if they are thrown to the man overboard, particularly if the water is choppy. Also, there is little the thrower can do to steer the lifebuoy once it is in the sea.

It is also known to project a recovery line into the water by means of a launcher, but again this has to be aimed very accurately in order to find the man overboard, who is likely to be in distress and so not fully alert to rescue attempts.

Whilst the term “man overboard” is commonly used in the art, it is of course to be appreciated that the present invention is equally applicable to woman and so herein the term “man” is to be read to include women.

Furthermore, it is to be noted that oil spills are becoming more frequent, and also more severely punished. Over 80% of reported oil spills occur within port or harbour areas. The majority are small in size and result from normal operations such as loading and bunkering.

According to a first aspect of the invention, there is provided an inflatable boom, the boom being elongate and being provided with at least one line by means of which the boom can be launched from a watercraft into surrounding water.

Such an inflatable boom may be used as a life-saving device; in such a case the boom would be launched from the watercraft into the surrounding water. The boom could be launched in the general direction of the man overboard; the elongate nature of the boom means that the man overboard has a larger target to aim for.

Typically, the boom would be at least 20 feet long but typically 100 feet long.

The line may be provided with a projectile, typically at one end thereof. The projectile may be arranged to be launched from a suitable launcher, such that launching the projectile draws the boom in the direction of launch, typically into the water. The projectile may be ballistic, in the sense that its movement is unpowered other than the momentum imparted to it by the launcher, or may be self-propelled. Typically, the projectile would have significantly greater mass than the line. Such a projectile can be considered “weighted”.

The boom may have an unlaunched state and a launched state, which the boom assumes after launch, the launched state of the boom occupying relatively more space than the unlaunched state. Typically, the launched state may comprise an inflated state, whereas in the launched state the boom may be less inflated, typically substantially uninflated.

The boom may be provided with a housing in which it is housed in the unlaunched state. Typically, it would not be possible to house the boom in the housing in the launched state. In a preferred embodiment, in the unlaunched state, the boom is folded or wound into the housing so that the length of the housing is significantly less than the length of the boom in the launched state.

Such a boom is very useful as it allows for compact storage on board the craft, but allows for a long inflated boom to be quickly provided on the water's surface adjacent to the man overboard.

The boom may comprise an elongate hollow tube. It will typically comprise an inflation system which is arranged to inflate the boom when it assumes the launched state. Typically this would be when the boom hits the water, or when it is launched. In the former case, the inflation system may be arranged to determine when it hits the water's surface and on that determination inflate the boom.

Preferably, the inflation system is activated by action of launching. Mid-air inflation has been found to be particularly convenient and to provide repeatable results with the aiming and placing of the boom. Indeed, the inflation system may activate due to the change in kinetic energy or momentum of the boom or the inflation system.

The inflation system may comprise a mass separated from an activator in the unlaunched position, but which is able to move to activate the activator when the boom is launched. The inflation system may therefore comprise a spring normally acting to separate the mass and the activator, the change in momentum of the remainder of the inflation system relative to the mass causing the mass to move towards the activator against a biasing force due to the spring. The activator may comprise a valve, or a piercing member such as a needle arranged to pierce a reservoir of compressed gas on activation by the mass.

The boom may be provided with a plurality of guide lines. These are typically elongate flexible members attached at one end to the inflatable boom, the distal end typically being retained at the launching position. In one embodiment, lines are provided connected at each end of the boom and at one third and two thirds along the length of the boom.

By manipulation of these lines, the boom can be steered to meet the man overboard, and to guide the boom back to the craft once the man overboard has grasped the boom.

The boom is preferably provided with at least one light source, which illuminate in the launched state of the boom. By lighting the boom, a man overboard has more chance of finding the boom in dark or choppy seas.

There may be a plurality of light sources, spaced along the length of the boom. However, in a preferred embodiment, the light source is internal to the boom, with at least one window in the wall of the boom allowing the transmittal of light from therewithin. Preferably, there is a plurality of windows spaced along the length of the boom. This means that a single light source can illuminate the boom along various positions along its length, and may avoid the need to power a plurality of light sources along the length of the boom or may indeed illuminate the boom by means of having the light source “sandwiched” into the construction of the unit upon manufacture (to be located between the harness and the inflatable tubing itself).

In such a case, at least part of the internal wall of the boom may be reflective; preferable the wall is at least 90% reflective. This enables the light from the light source to be reflected down the internal walls of the boom when inflated, in a manner similar to an optical fibre. Alternatively, refractive surfaces or media may be provided within the boom in order to transmit the light from the light source to the windows.

In an alternative, instead of being provided with windows, the boom may be partially transmissive, such that the boom “glows” when the internal light source is illuminated.

In order to illuminate in the launched state, the light source may be provided with a pressure-activates switch, such that an increase in pressure consequent upon inflation of the boom activates the switch and hence causes the light source to illuminate. In the alternative, the light source may be provided with an impact activated switch, such that impact of the boom on the water's surface activates the switch and causes the light source to illuminate.

In one embodiment, slits may be provided through the boom so that a man overboard can pass himself therethrough to secure himself to the boom.

We have also appreciated that the boom of the present invention can be used not only to rescue men overboard, but to surround oil spills and the like. The boom can be projected onto the water's surface around an oil spill, and then guided around the oil spill to contain it. Accordingly, the boom may comprise a skirt, which in use in the launched state depends from the boom downwards below the water's surface. Preferably, the skirt depends at least 9 cm below the boom. The boom may also be provided with a skirt which extends upwards above the boom in the launched state. This may extend at least 9 cm above the boom.

According to a second aspect of the invention, there is provided a kit comprising an inflatable boom according to the first aspect of the invention, together with a launcher arranged to, in use, launch the projectile in order to launch the inflatable boom.

The launcher is typically a compressed gas launcher, such as a compressed air or compressed carbon dioxide launcher or a combination of both.

According to a third aspect of the invention, there is provide the use of the inflatable boom of the first aspect of the invention, or the kit of the second aspect of the invention, in rescuing a person who has fallen into a body of water.

According to a fourth aspect of the invention, there is provided a method of containing an oil spill, comprising using the boom of the first aspect of the invention or the kit of the second aspect of the invention. Preferably, the boom is fired onto the water's surface adjacent to the oil spill, and then is guided to surround and/or pull back the affected area as to recover the oil spill back towards the source.

Herein, “oil spill” is used to describe a discharge of a largely immiscible liquid onto the surface of a body of water. In particular, it refers to such a discharge that floats on the water's surface, and in particular to the discharge of hydrocarbon-based oils or other such fluid like hydraulic liquid or other noxious substances.

According to a fifth aspect of the invention, there is provided an inflatable boom, comprising a hollow tube and a light source internal to the hollow tube, in which light emitted by the light source in use is transmitted through the walls of the tube.

The internal walls of the tube may be reflective so that light emitted by the light source is transmitted along the boom maybe even if the boom is bent. The boom may also be provided with at least one, but preferably a plurality of transparent windows along the length of the boom. Light may therefore be emitted through the windows. In an alternative, the walls of the boom may be light transmissive, such that light from the source can be emitted through the walls of the boom.

Such a boom may be used in the manufacture of any inflatable structure, such as an inflatable raft or a rigid inflatable boat (RIB).

There will now be described by way of example only an embodiment of the invention, described with reference to the accompanying drawings, in which:

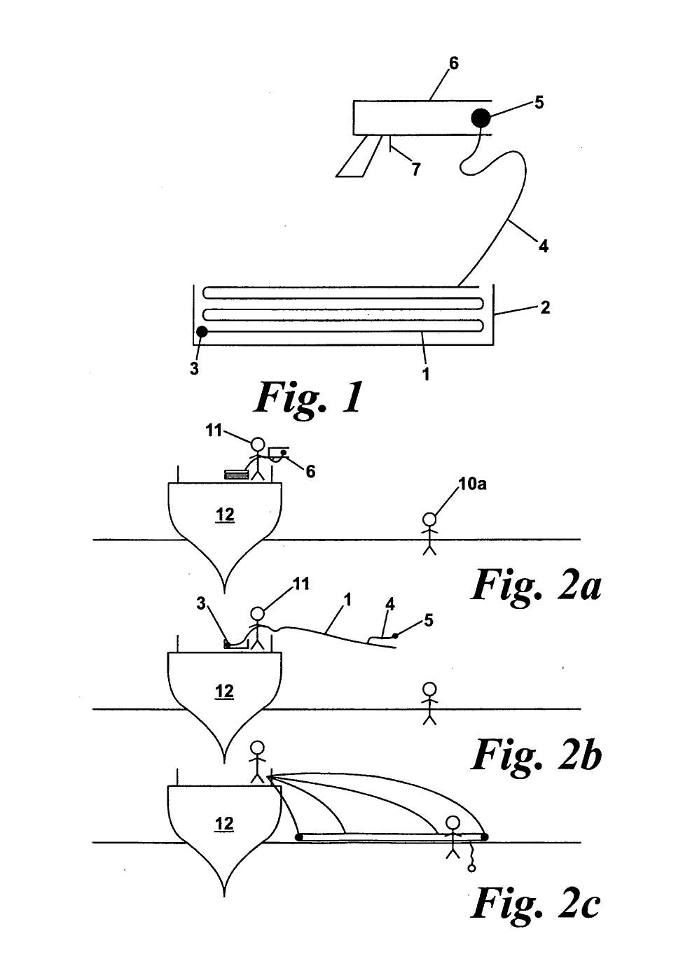

FIG. 1 shows a schematic view of an inflatable boom according to a first embodiment of the invention;

FIGS. 2a to 2c show in schematic elevation the deployment of the inflatable boom of FIG. 1 in use;

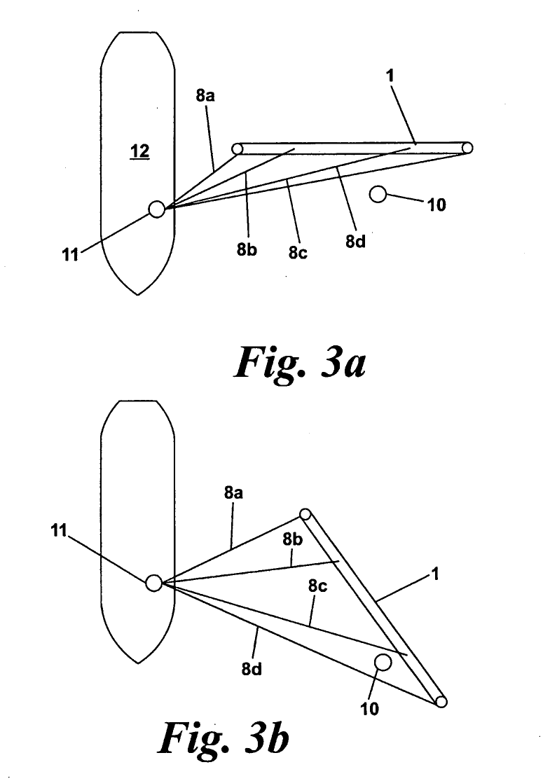

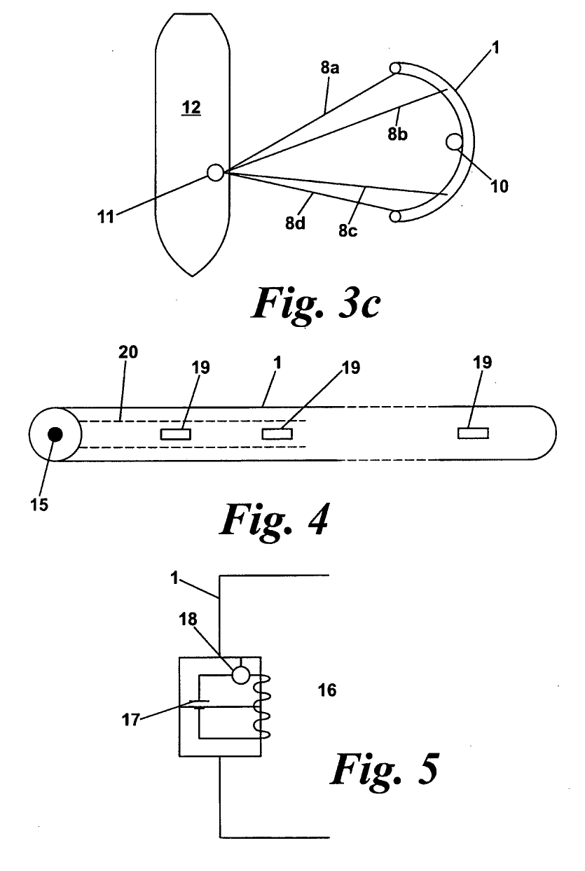

FIGS. 3a to 3c show in plan view the further deployment of the inflatable boom of FIG. 1;

FIG. 4 shows a part sectional view of the illumination system of the boom of FIG. 1;

FIG. 5 shows an enlarged cross sectional view through the light source of FIG. 4;

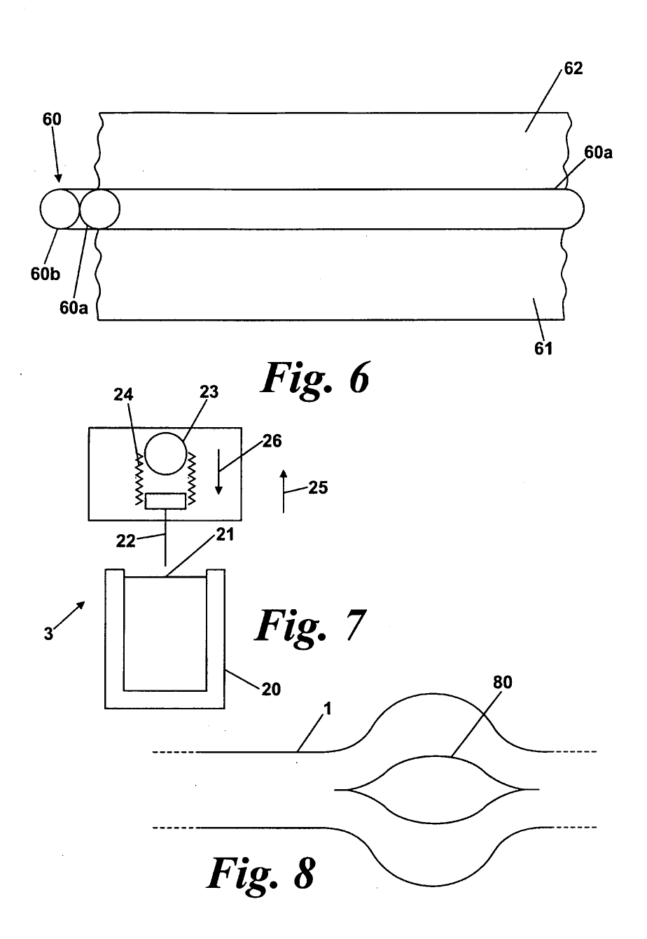

FIG. 6 shows an inflatable boom according to a second aspect of the invention;

FIG. 7 shows the inflation system of the boom of FIG. 1; and

FIG. 8 shows an inflatable boom according to a third embodiment of the invention.

FIG. 1 of the accompanying drawings shows an inflatable boom system according to a first embodiment of the present invention. In the unlaunched state shown in FIG. 1, the system comprises an elongate inflatable boom 1 which in the unlaunched state is uninflated. It is stored folded within a housing 2. The method of folding is relatively unimportant—as long as it can exit the housing 2 with sufficient speed during its deployment as discussed below. The housing is shown in FIG. 1 without a lid, but a lid would generally be provided, but removed before use.

The boom comprises a length—at least 20 feet—of airtight hollow tubing, typically formed of polyurethane or other suitable material. It should be of relatively high strength, so that it can bear the weight of a man overboard in use. As such, the strength may be engineered into the fabric of the tube itself, or the tube may be provided with strengthening on the tube walls. However, the material should be generally lightweight, for convenience of storage and use.

At one end of the inflatable boom 1 there is provided an inflation system 3. This comprises a supply of compressed gas (air, for example) that is released when the boom is launched.

The inflation system can be seen in more detail in FIG. 7 of the accompanying drawings. It comprises a reservoir of compressed gas 20 having a seal 21. Should this seal 21 be ruptured, the compressed gas can escape into the body of the boom 1. The means by which this occurs is an activation needle 22. This is normally held away from the seal 21, but can be activated by a mass 23 of the form of a ball bearing. This ball bearing is separated from the activation needle by a spring 24. However, when the boom 1 is launched in the direction of arrow 25, the momenta of the remainder of the inflation system 3 and the mass 23 will be different, and so the mass 23 will move relative to the inflation system 3 in the opposite direction to 25, shown by arrow 26. As the launch is relatively violent, it will collide with the activation needle 22, forcing it into seal 21. The seal 21 is thereby ruptured, which inflates the boom 1.

At the other end of the inflatable boom 1 there is attached a line 4 by means of a D-ring (not shown). The line connects the boom 1 at one of the line's end to a projectile 5 at the distal end of the line 4. This projectile 5 is suitably heavy that it acts as a ballistic projectile (overcoming a substantial amount of air resistance) when launched. Typically, it would have a mass of about 1.5 kg.

In order to launch the inflatable boom, the projectile 5 is fitted within a launcher 6. Whilst any suitable launching technology can be used, in the present embodiment a compressed gas launcher is used. In this, a user aims the launcher 6, then presses a trigger 7. This releases a charge of compressed gas held within the launcher 6. The increase in volume of the compressed gas as it is released launches the projectile 5 from the launcher 6 in a ballistic fashion.

The method of using this inflatable boom system can be demonstrated with reference to FIGS. 2a to 2c and 3a to 3c of the accompanying drawings. In FIG. 2a, a man 10 has fallen overboard off ship 12. He will henceforth be referred to as the “man overboard”. A rescuer 11 is alerted to this fact, and picks up the launcher 6, dislocating it from its storage area if necessary. He aims the launcher over the head of the man overboard 10. For convenience's sake, the launcher is should-mounted. The rescuer 11 fires the launcher 6 using the trigger 7. As the projectile is launched from the launcher 6, it draws the boom 1 from its housing 2 in the general direction of the man overboard 10, as shown in FIG. 2b. A range of 30 to 80 metres is possible.

In FIG. 2c, the boom 1 has settled on the water's surface. As the inflation system 3 hits the water's surface, the compressed gas held therewithin is released, inflating the boom 1.

This position can be seen in plan view in FIG. 3a of the accompanying drawings. Also visible in FIGS. 3a to 3d are four recovery lines 8a to 8d, fixed via D-rings to the end, one third, two third and far end positions along the length of the boom 1 respectively. These are retained by the rescuer 11 when the projectile 5 is fired. In the position of FIG. 3a, the boom is shown in its natural position as fired—linear. However, by manipulation of the recovery lines 8a-8d, it is possible to move the boom around and change its shape. In one embodiment two rescuers or crew can go with the lines to the bow (one) and to the stern (two) at the same time to steer the unit to the best position for recovery of the individual or to collect the spill.

This is shown in the successive FIGS. 3b and 3c. In FIG. 3b, the rescuer 11 has moved the boom behind the man overboard 10. The man overboard 10 can now grasp the boom 1, or merely rest against it if he is incapable. By simply raising his arms as the boom hits him, and then lowering them once that happens, the man overboard 10 can safely engage the boom 1.

By further drawing in the end recovery lines 8a, 8d at the expense of the middle lines 8b, 8c, the rescuer 11 can draw the boom into a semicircle as shown in FIG. 3c to envelope the man overboard 10, and then drag the man overboard 10 towards the boat 12, where he can be pulled from the water.

Whilst this embodiment has been described with reference to a man falling off a boat, it could equally well be used from land to rescue someone who has fallen of a quay, cliff, pier or the like.

The device of this embodiment can be made extremely compact and lightweight to be man-portable whilst still being completely self-contained. Typically, the housing 2 would be mounted (with its lid on) centrally below the launcher 6, with locating clips positioned towards the top of the housing.

The boom also includes a light source 15 mounted in the end wall of the boom that also supports the inflation system 3; this is shown in more detail in FIGS. 4 and 5 of the accompanying drawings. The light source comprises a plurality of light emitting diodes (LEDs) 16 connected to a power source 17 (in this case, a battery) via a pressure-activated switch 18. The pressure-activated switch connects the LEDs 16 to the power source 18 when the pressure inside the boom 1 rises, indicating inflation of the boom. The LEDs 16 then illuminate.

The light emitted by the LEDs 16 passes through the interior of the boom 1. The boom 1 is provided with a plurality of transparent windows 19 spaced along the length of the boom 1. These allow the light to escape, thus providing illumination of the boom enabling the man overboard 10 to find the boom 1 more easily. However, in order to ensure that the light reaches the windows 19, a reflective coating 20 is provided on the inner walls of the boom 1. This means that the light is internally reflected along the inside of the boom 1 in a similar manner to light being reflected along an optical fibre. Thus, even when the boom is drawn into a semi-circle as shown in FIG. 3c of the accompanying drawings, the light can be transmitted from end to end of the boom 1.

An inflatable boom according to a second embodiment on the invention is shown in FIG. 6 of the accompanying drawings. This boom 60 is identical to that of FIG. 1 except that it has skirts 61 and 62 depending downwards and extending upwards from it in the launched, inflated state.

This boom 60 comprises two elongate tubular members 60a, 60b that can be independently inflated (although independent inflation is not essential). These are attached together so that the booms lie adjacent and parallel on the water's surface in use. Such a boom can be used to contain oil spills; the method of use is the same as described above with reference to FIGS. 1 to 5, except that in place of the man overboard 10 there is an oil spill.

Particularly the lower skirt 61 can be weighted, so that in use the skirt is biased downwards, so that the boom 60 assumes the correct orientation. The ends of the boom 60 can also be weighted, so as to ensure effective containment against the vessel once the boom has been successfully drawn up against the vessel. The oil spill can then be recovered by means of absorption pillows or suction.

FIG. 8 of the accompanying drawings shows a possible improvement to the boom of FIG. 1; it is provided with slits 80 therethrough at intervals along the boom's length. A man overboard can find one of these slits and pass himself therethrough in order to secure himself to the boom 1. The slits are air-tight, in that the slit in the top of the boom is connected by a double layer of tube wall material to the slit at the bottom, forming a passage for the man overboard's body.

As can be seen, the inflatable boom according to this invention could be employed by military and rescue organisations, coastguards and marine police, shipping and fishing organisations and operators, gas and oil installations, harbour patrol organisations, the passenger and cruise industries, helicopter recovery operators, leisure mariners and inland waterway safety authorities, to name but a few. The lifesaving version can remove the need to launch a recovery boat, or even save lives that were not possible where rough seas prohibit the launching of such a boat, as the invention could be used in rougher seas or stronger winds than a recovery boat. With the illumination feature, the boom can be visible for up to three nautical miles.

There now follows as part of this description the descriptions of the inventor's previous applications, to aid in the understanding of the present invention.

### Sea Sling Recovery System

### Stowage Launching & Recovery System

The present invention relates to an innovation to recover individuals from the water at a distance via launchable projectile deployment and stowage in an incorporated container for deployment.

It is known to project a recovery line into the sea via a launcher and attached line and known that inflatable pouches float.

It is now proposed: A device for a sea-faring vessel having a connected housing in which is stowed, in an unextended state, a length of inflatable boom. The boom is automatically ejected from the housing on or soon after pulling the trigger on the launcher facilitating in the launching of the projectile and drawing out of the apparatus from the box beneath it. Once hitting the water the boom is inflated to form a long inflated boom upon contact with the water. The device allows a crew member of the first vessel to take action to recover an individual afar from the vessel or area of launch.

It should be noted that as used herein the term “projectile” has various meanings and can be the vehicle, typically launched from a compressed air launcher, which carries the recovery boom from a ship deck or other launch platform to the floating “man over board” or other individual. The weighted projectile or component used to draw out the boom or “sling” (from the container) is launched via the launcher into position on the surface of the water behind the individual.

Difficulties have been experienced in ensuring the element is compacted into a small enough deployment box and other such issues have arisen as stowing the element into a container while maintaining ability of “clean” deployment or to be projected out of said box correctly into position on the waters surface.

There have also been problems with the use of a container being designed in such a way to minimise air resistance upon launch and problems with ensuring a wide enough catchment area is maintained.

The object of the present invention is to improve the system of recovery and produce a recovery device that will enable recovery of individuals remotely from waters in these circumstances the efficiency of a container in which a fouling element is stowed, compacted and maintained ready to be deployment by means of being drawn out of the box, which is positioned below the launcher, or such a similar container, via a weighted projectile.

Other attributes of this application are to include a system to inflate the tube and a tube or boom which should be strong enough to withstand the drag coefficient upon drawing the individual back to the vessel or shore as to maintain a wide catchment area. The particular design can be described by way of the following descriptions.

The booms are manufactured from a flat hollow tube cut to size as per requirement. At one end there is situated a inflation system which activates on contact with water. The boom apparatus is launched over the head of the located individual in the water. The inflator hits the water's surface and inflates the boom. A series of connection lines are attached to the boom. One at each end (for example) and two more (placed at regular ⅔rds along) attach the boom to a recovery line. The lines help maintain a wide encatchment area as the recovered pulls in the individual, as to maintain formation and success of recovery with the help of a pressurised boom or tube. The tube itself may be constructed from material (in a tubular form) with the strength to hold up under force or a simple tube with material/s added to the back front or other on the tube to enhance strength of the tube. At each connection point along the tube, there are fast connections to allow recovery ropes to be connected.

The materials used in the construction of the boom are lightweight materials and recovery lines.

According to the invention there is provided a recovery system stowed in a container under a launcher as detailed above having:

Specific materials such as polyurethane tubes or other such material is to be used to form a light weight, high strength, replaceable and effective inflation device sufficient to recover individuals from water remotely a system to launch the projectile carrying the apparatus and a system to inflate the apparatus upon hitting the water and associated connection or recovery lines, stowed in the launching container.

A variant of the design also includes a version which is extremely compactable, lightweight as to combine to be a totally man portable and fully self-contained operational launcher package.

The element container is designed to be (fully detachable from the launcher when not in use) positioned centrally under the launcher ready to be used via locating clips positioned toward the top of the container.

The elements construction can result in an element of any length, depth or width of product but is envisaged so must be built to suit the element dimensions being used at the time.

The box is designed to contain and deploy any such recovery lines, and inflators required to operate correctly. In some designs a “D” ring is used at either end for recovery after deployment into position and or for attachment of recovery and stability lines as to maintain form as are other such fastening/fixing lines to hold the unit into a wide area position. All apparatus required are contained in the stowage container below the launcher.

The system is designed to be lightweight as possible as to be launched as far as possible with the container designed to be a stowage system. The unit is designed for being used in a shoulder launched projectile system as well as a static mounted system for longer distance deployment, or possibly a remote controlled fixed mounted launcher as well as a portable manually deployed container.
To help understanding of the invention, a specific embodiment thereof will now be described by way of the example with reference to the accompanying drawings:

### Inflatable Recovery Boom System

The above-described recovery system is stowed in the hold of any vessel or area on shore etc. A situation arises where the unit is required to be used. The launcher is already charged, connected to the apparatus and all such recovery lines are pre packed into the unit's container. The operator reaches for the unit by picking up the launcher and connected deployment and boom system (dislocating it from its storage area.) The operator picks up the whole assembly, settles into a firing posture, and is then ready for aiming and firing over the head of the located individual in the water, into position far behind him/her. The boom is then launched from a shoulder launcher by means of compressed air launched projectile to the rear of the individual.

The unit flyies through the air and then falls onto the surface of the water behind said individual. Upon impact with the surface the boom begins to inflate with Co2 or air, once complete the inflation makes the boom quite stiff and when under the pressure from being pulled toward the launch point (by the recovery liness attaché) the boom begins to “bend” the bending reaches a maximum (predetermined by the recovery lines attached two thirds the way along) and forms a semi-circular condition. The boom is continued to be pulled through the water and meets the individual in the water. The individual (now positioned in the centre of the boom configuration) raises his arms and allows the boom to envelope him. Once firmly in the booms configuration the individual lowers his arms and is interconnected with the recovery apparatus. The individual is now able to be pulled from the water and recovered.

### Maritime Inflatable Illumination System MK1

The present invention relates to an innovation to aid in the initial location of finding and then recovering individuals from water via the design of an inflatable lighting system and other applications.

It is known to project a recovery ring and line into the sea via a launcher or by hand, and known that inflatable structures float and that typically most inflation systems are geared toward life jackets and rigid inflatable rib boats.

It is now proposed: A small lightweight device for inside any inflatable boom or booms as to emit a light source into a tubular or other construction with or without a reflective surface outside or inside the tubular construction to deflect or refract generally redirect the light produced.

The reflector or refractor surface also acts to intensify if light is directed onto or at it through the clear tubing in addition to the light sources at either end of the tube. Imagine once the tube is inflated this will form a rod like formation. When the ropes attached to the ends of the inflated tube are pulled the whole tube will bend toward the direction of the force pulling on it until the centre catches up. The reflector is designed to bounce this light off it and further along the tube, and repeat this process until the light reaches the other end, thus creating the illumination of the entire tube. It should also be noted that in one application the reflective surface is used to reflect the lights in the end caps (detailed below) to bend the light in a circle inside the tube so it will travel effectively, around the tube from end to end. A by product is to illuminate the whole tube evenly. The reflector tape in conjunction with the light source is also an important element in this application.

It should be noted the device (basically a mini torch) could be made in any size or shape and even as to focus the light in both axis at once and to suit any particular purpose or requirement of any inflatable structure boom or tubular member. Typically, the lightweight construction is achieved by using the latest technologies for producing the light via, high intensity LED's or Light Emitting Diodes and miniature power source/s as in a collection of small watch batteries connected in series. LED's are used but this can be altered to any other light source such as incandescent, fluorescent or other mixture of gaseous and or electrical and or electro-chemical interaction inside the boom or tube. LED tapes have also been considered but problems with sufficient power supply being attached to the remote use of the inflatable booms function. LED tapes can be used in addition where a power scours is available so the above description should also be mentioned in the application for static barrier or oil boom uses. The light source may even be built into the tube or end cap/s instead of a separate entity and so should be noted as an important feature. In one embodiment there are several light sources in the boom or tube for example one in the middle shining in two opposing directions and one more at each end. The above description is all encompassing to the result, production of a luminescent tube for visibility at sea or night purposes.

The technology may not be limited to uses in oil, recovery or other inflatable tubes/booms but any inflatable or pressurised construction for example an inflatable raft being a series of tubes attached together at the sides or indeed in a R.I.B Rigid Inflatable Boat for whatever purposes.

Difficulties have been experienced in getting the unit to operate as desired internally inside the hermetically sealed tubing. This has been overcome by the design and implementation of a micro pressure switch. The switch can be likened to that of a conductive printed circuit inside a waterproof membrane keypad. The micro membrane switch is designed to remain in the non-contact position or “off” until the inflated component is inflated. The compressed air pressure is the actuation instrument as to compress the micro bubble switch into the connection position or to activate the light source and illuminate the inside of the tube, automatically. The switch is also a relevant part of this application so protection is sought here. The switch is capable of being used to turn on other electronic equipment for example an emergency transmitter, radio system inside a life buoy or other alarm equipment.

There have also been problems with the miniaturisation of the light emitting device. The unit is designed to fit into a small end cap and locate fastly with adhesive. The inflation (in this case) is outside the inflatable tube. This being the case the gas must pass into the tube via the end cap and through on into the tube or boom. The torch (which is fitted into the end cap must not interfere with the inflation and so is positioned on an attached “scaffolding” structure to prevent blockage of the airflow.

The object of the present invention is to apply for patent protection on all of the detailed attributes of this application.

Other attributes of this application are to include any combination of the following, a self contained and or an integral or independent light source or an internal or external power source providing energy into the sealed tube/boom or inside an inflatable product for any electrical switching purpose with or without light being the result of activation under air or gas pressure. A further attribute is the ability of the unit to withstand shock. In some cases the boom will be launched into position and undergo very large impact forces exerted onto it so is shock proof. The unit will be further developed to be as small as possible and or integrated into the products other components as standard I.e. 1 or more inflation components upon manufacture.

The unit (power source, body or container if there is one, and a light emitting device together with the pressure sensitive dome, membrane, bubble or other pressure or inflation activated switch) and the materials used in the construction of the device, are all designed to be strong and lightweight materials for the purposes of launching or throwing the inflatable unit/s into position and for compaction into the packing housing the apparatus in a compact form.

Further protection is sought by providing the note that the material the boom or other as above is constructed from may be capable of emitting an integral or external light source itself and as to breech this application. Additionally, an impact switch may also be used to overcome this application, as could a motion sensor with a permanent “on” function and a connection breaking switch in the case of a unit being launched into a position and being activated this way. The technology of activation, light and tubes, and the concept itself are sought for protection under this application.

According to the invention there is provided an automatic light unit containing sufficient components as to operate as described above having one or more of the components necessary to operate as described above:

To help understanding of the invention, a specific embodiment thereof will now be described by way of example with reference to the accompanying:

### Inflatable Illumination System

The above-described inflation unit/s are stowed on the deck of any vessel or area on shore etc, in case of needed use. A situation arises where the unit/s is required to be used for example a man overboard situation or an oil slick. The inflation device is thrown or launched, or dragged out (positioned) in the water. The unit inflates or is inflated before deployment and emits the light detailed. The light is there to attract attention in the dark for whatever purpose as a warning, awareness, or a visual aid to an observer. The light passes constantly along the tube to act as a fluorescent or reflects off the reflector to transpose throughout the tube in either way the inflatable device is luminescent to the observer in the dark. The reflective tapes are operating to focus the light in a concave fashion if the boom (for example) is pulled into a curve or bow by connection lines.

### Velocity Actuation Inflation System

The present invention relates to an innovation to aid the recovery of individuals from the water or other use for/at a distance via any kind of launchable projectile deployment system and principally the kinetic activation of an inflation system/s into a or attached to or via a pneumatic line throwing device to deploy such apparatus, that is to be connected to and operate with any inflation system.

It is known to project a recovery line into the sea via a launcher and attached line and known that inflatable pouches float.

It is now proposed not only: A device for any sea-faring vessel, platform or other having connected an inflatable component in or outside of a housing in which it is stowed, in an unextended state, an inflatable, but a means to inflate such an inflatable via kinetic energy produced under the impact of launch conditions provided by such a launch.

For example. An “inflatable boom/s” is/are automatically drawn out of a housing by being drawn (being pulled out of the box) via the projectile being launched out of the launcher, operating (under any pyrotechnic or compressed air or gas) of the launching system.

Once hitting the water “the boom” is intended to form a long inflated tube on contact with the water semi parallel to the launch trajectory. The device allows a crewmember or operator to take action to recover an individual from the water, within the area of launch or range.

Difficulties have been experienced in ensuring the element forms into a parallel line at 90 degrees to the direction of launch (which is required) and other such issues have arisen as inflating a tube on the water due to water viscosity and twisting of the fine boom membrane while under the pressures of said inflation. Also stowing the element into a container while maintaining ability of “clean” deployment or to be projected out of said box correctly into position on the waters surface.

There have also been problems with the use of a container and still minimise air resistance upon launch and problems with ensuring a wide enough catchment area is maintained as detailed above.

The object of the present invention is to improve the function under the operation of a recovery device as to produce a recovery device that will actually begin to inflate from the split second of launch, automatically as to enable fast and efficient deployment in the recovery of individuals remotely from waters. The principal design uses the objective of having the inflation system, gas to inflate and the connected inflation trigger all working together in the projectile or attached to the inflatable somewhere in its connected construction.

One principal design houses the above in the projectile and a further houses the inflation system at the rear of the boom or inflatable component but both are connected to the inflatable itself. A combination of the two is also envisaged later.

The main principal for activation can be described by the following description. Inside the projectile are all of the necessary components for operation and inflation of the inflatable tube, boom or other. The activation system is a critical component of correct operation of the components to the product to function correctly. In this embodiment, all components are stowed in the projectiles head. The activation device is described as being a weight or ball bearing in the head of the inflation product itself, which is supported upon a spring to separate the ball bearing from the activation plunger situated below it. While under non-launch conditions the spring effectively separates these two components from coming into contact with each other and therefore there is no activation of the inflation system. Upon launch of the product however, the forces exerted onto the projectile and namely ball bearing and spring (through the launching of the projectile out of the launcher) will overcome the springs strength to allow the ball bearing to smash into the plunger, which in turn pushes down a piercing pin into the cylinder head and releases the gas into the attached or connected inflatable via a connected tube. It should be noted protection is sought on the concept of an inflation system designed to inflate any product upon deployment by any means automatically. Further more, it should be noted conceptually the spring described may be replaced with any other form of retaining device such as glue, rubber, sponge or any other system as to at chive this function of separation of the two until launch pressure is attained. At this point the plunger and inflation system are readily available but the actuation system in key to operation correctly for inflation.

Other attributes of this application are to include the fact if inflation occurs in mid air, there is little resistance to the inflation of the tubes, booms or product under these split second conditions preventing problems such as twisted tubes or other inflation resistance. Furthermore, this inflation system enhances the use of booms or tube in the function of the product by the fact once the booms are inflated prior to the unit hitting the water, the tubes form solid rods under inflation pressure and as the projectile stops in the water the weighted end caps naturally fall out further away from the centre of the landing point and help achieve the above described formation (at 90 degrees to the launch direction. This ensures, consequently, the most open configuration of the booms possible covering the widest possible area for recovery of the individual. It should also be noted the same technology is to be used in the recovery of oil, spillages at anchor or recovery of hazardous material on the surface of the water so should not be limited to purely a rescue device. Other applications are currently being sought using this new technology.

The materials used in the construction of the boom or inflatable product are all designed to be of lightweight materials and recovery lines.

According to the invention there is provided a recovery, spill retention, system/s stowed in a container with or without a launcher being in a box (could be separately used when needed for other jobs such as line throwing) as detailed above having:

Specific components as a automatic inflation actuator, a gas or air supply, an inflator body with internal or external components as to release gas into the system, a projectile and a means of connection together with an inflatable device via any form albeit flexible tubes and connection components or rigid pipes (also envisaged) is the inflator connected directly to the inflatable (integral).

A variant of the design also includes a version which is extremely compactable, lightweight as to combine to be a totally man portable and fully self-contained operational launcher package.

The element container is designed to be (fully detachable from the launcher when not in use) positioned centrally under the launcher ready to be used via locating clips positioned toward the top of the container. All of the components are to be stowed in the container and already connected together ready for use.

The elements construction can result in an element of any length, depth or width of product but is envisaged so must be built to suit the element dimensions being used at the time.

The box is designed to contain and deploy any such recovery lines, and inflators required to operate correctly. In some designs a “D” ring is used at either end for recovery after deployment into position and or for attachment of recovery and stability lines as to maintain form as are other such fastening/fixing lines to hold the unit into a wide area position. All apparatus required are contained in the stowage container below the launcher as in a magazine system or as in a separate box which supports the use of a multi purpose launcher not contained in the same box.

The system is designed to be lightweight as possible as to be launched as far as possible with the container designed to be a stowage system. The unit is designed for being used in a shoulder launched projectile system as well as a static mounted system for longer distance deployment, or possibly a remote controlled fixed mounted launcher as well as a portable manually deployed container.
To help understanding of the invention, a specific embodiment thereof will now be described by way of example with reference to the accompanying drawings:

### Inflatable Automatic Velocity Activated Component

The above-described actuation system is stowed in the hold of any vessel or area on shore or anywhere by water, etc. A situation arises where the unit is required to be used. The launcher is already charged independently or in conjunction with this apparatus. For example in a man overboard scenario there is a requirement to rescue and individual from the water. The rescuer goes to the stern of the ship (in this embodiment) opens the box in which is stowed all of the connected apparatus above which is charged and ready to go. The operator opens the box, removes the projectile, inserts the projectile into the charged launcher, steps behind the launch box (in this example), which is on the deck of the vessel and fires the projectile over the head and behind the individual in the water.

All of the connected apparatus (such recovery lines are pre packed into the unit's container already). The actuation sensor or components ball bearing compressed the spring holding it away from the plunger and because of launch strikes the plunger with extreme force piercing the pressurised cylinder and releasing the gas into the booms, which then are rapidly inflating in mid air. Upon contact with the waters surface, the projectile sinks below the surface while the rigid booms (in this example) continue to travel further on and open out due to kinetic energy produced by the launch. When the buoyant projectile and boom tubes float to the surface the operator reaches for the pre-attached recovery lines and proceeds to pull these back toward the ship. Because of the rigidity of the tubes under pressure, the tubes tend to push outward to the sides of the centrally connected projectile and form a parallel 90 degree encatchment area to encompass the individual. The continued pulling on the guide ropes recovers the individual as well as all of the connected components launched. The above description would operate similarly for use in an oil spill in dock or at anchor but the employment of oil, skirt would be used and not a recovery harness as described in previous applications. The same technology would be used in both applications just with different products for different uses.

1.-34. (canceled)

35. An inflatable boom, the inflatable boom being elongate and being provided with at least one line by means of which the inflatable boom can be launched from a watercraft into surrounding water.

36. The inflatable boom of claim 35, in which the at least one line is provided with a projectile at one end thereof.

37. The inflatable boom of claim 35, in which the inflatable boom has an unlaunched state and a launched state which the inflatable boom assumes after launch, the launched state of the inflatable boom occupying relatively more space than the unlaunched state.

38. The inflatable boom of claim 37, in which the inflatable boom is provided with a housing in which the inflatable boom is housed in the unlaunched state.

39. The inflatable boom of claim 38, in which, in the unlaunched state, the inflatable boom is folded or wound into the housing so that a length of the housing is significantly less than a length of the boom in the launched state.

40. The inflatable boom of claim 38, in which the inflatable boom comprises an inflation system which is arranged to inflate the inflatable boom when the inflatable boom assumes the launched state.

41. The inflatable boom of claim 40, in which the inflation system is arranged to inflate the inflatable boom when the inflatable boom hits the water, or when it is launched.

42. The inflatable boom of claim 41, in which the inflation system comprises a mass separated from an activator in the unlaunched position, but which is able to move to activate the activator when the inflatable boom is launched.

43. The inflatable boom of claim 42, in which the inflation system comprises a spring normally acting to separate the mass and the activator, a change in momentum of a remainder of the inflation system relative to the mass causing the mass to move towards the activator against a biasing force due to the spring.

44. The inflatable boom of claim 43, in which a plurality of guide lines are provided, the guide lines being elongate flexible members attached to a first end of the inflatable boom, a second, distal, end of the inflatable boom being retained in use at the launching position.

45. The inflatable boom of claim 44, in which a plurality of guide lines are provided, the guide lines being connected at first and second ends of the inflatable boom and at one third and two thirds along a length of the inflatable boom.

46. The inflatable boom of claim 35, in which the inflatable boom is provided with at least one light source, which illuminates in the launched state of the boom.

47. The inflatable boom of claim 46, in which the at least one light source is internal to the boom, with and in which the inflatable boom is provided with at least one window in the wall of the inflatable boom allowing the transmittal of light from within the inflatable boom.

48. The inflatable boom of claim 47, in which there is a plurality of windows spaced along the length of the inflatable boom.

49. The inflatable boom of claim 47, in which the inflatable boom has an internal wall which is reflective.

50. The inflatable boom of claim 46, in which the at least one light source is internal to the boom and in which the inflatable boom is partially light transmissive, such that the boom glows when the internal light source is illuminated.

51. The inflatable boom of claim 46, in which, in order to illuminate in the launched state, the at least one light source is provided with a pressure-activated switch, such that an increase in pressure consequent upon inflation of the inflatable boom activates the pressure-activated switch and hence causes the at least one light source to illuminate.

52. The inflatable boom of claim 51, in which the water has a surface and the at least one light source is provided with an impact activated switch, such that impact of the inflatable boom on the water's surface activates the impact activated switch and causes the at least one light source to illuminate.

53. The inflatable boom of claim 35, in which slits are provided through the inflatable boom so that a man overboard can pass himself through the slits to secure himself to the inflatable boom.

54. The inflatable boom of claim 37, in which the water has a surface and the inflatable boom comprises a first skirt, which in use in the launched state depends from the inflatable boom downwards below the water's surface.

55. The inflatable boom of claim 54, in which the inflatable boom is also provided with a second skirt which extends upwards above the boom in the launched state.

56. A kit comprising an inflatable boom, the inflatable boom being elongate and being provided with at least one line by means of which the inflatable boom can be launched from a watercraft into surrounding water, in which the at least one line is provided with a projectile at one end thereof together with a launcher arranged to, in use, launch the projectile in order to launch the inflatable boom.

57. A method of rescuing a person that has fallen into a body of water, comprising launching an inflatable boom, the inflatable boom being elongate and being provided with at least one line by means of which the inflatable boom can be launched from a watercraft into surrounding water, and launching the inflatable boom, towards the person.

58. A method of containing an oil spill on a body of water having a surface, comprising using an inflatable boom, the inflatable boom being elongate and being provided with at least one line by means of which the inflatable boom can be launched from a watercraft into the water, in which the boom is fired onto the water's surface adjacent to the oil spill, and then is guided to surround and/or pull back the affected area as to recover the oil spill.

59. An inflatable boom, comprising a hollow tube and a light source internal to the hollow tube, in which light emitted by the light source in use is transmitted through the walls of the tube.

60. The inflatable boom of claim 59, in which the hollow tube has internal walls, the internal walls being reflective so that light emitted by the light source is transmitted along the inflatable boom even if the boom is bent.

61. The inflatable boom of claim 59, in which the inflatable boom is provided with at least one transparent window along the length of the inflatable boom.

62. The inflatable boom of claim 59, in which the hollow tube has walls which are light transmissive, such that light emitted by the light source can be emitted through the walls.

63. An inflatable structure, such as an inflatable raft or a rigid inflatable boat (RIB), comprising an inflatable boom, comprising a hollow tube and a light source internal to the hollow tube, in which light emitted by the light source in use is transmitted through the walls of the tube.
